(19) United States
(12) Patent Application Publication
(10) Pub. No.: US 2010/0059543 A1
(43) Pub. Date: Mar. 11, 2010

(54) CONTAINER FOR DISPENSING BEVERAGE

(75) Inventors: Arie-Maarten Paauwe, De Lier (NL); Antonius Maurits Willemen, Utrecht (NL)

Correspondence Address: Pearne & Gordon LLP, 1801 East 9th Street, Suite 1200, Cleveland, OH, 44114-3108, US

(73) Assignee: HEINEKEN SUPPLY CHAIN B.V., NL-1017 ZD AMSTERDAM (NL)

(21) Appl. No.: 12/514,994

(22) PCT Filed: Nov. 19, 2007
(86) PCT No.: PCT/NL2007/050573

§ 371 Date: Sep. 3, 2009

(30) Foreign Application Priority Data
Nov. 17, 2006 (NL) 1032893

(51) Int. Cl. B67D 7/00; B65D 83/00; B67D 7/06

(52) U.S. Cl. 222/1; 222/396; 222/80; 222/399

(57) ABSTRACT

Container (2) for dispensing beverage under pressure, which is provided with an inner space (4) for receiving the beverage to be dispensed, wherein a pressure control (8) is provided with a first compartment (16) and a pressure control compartment (50) closed towards the surroundings, wherein the first compartment is provided with a dispensing opening (32) with a shut-off (33) and driving means (17) are provided on the pressure control compartment for opening the shut-off, wherein a channel (35, 57, 62) is provided which, in opened position, is in open communication with the first compartment, wherein the pressure control compartment has a wall part (49) movable in an operating direction relative to the first compartment, which bears an operating element (68) which is slideable in, against or over said channel, and can release and seal off a gas feed-through path (62) between the first compartment and the surroundings, in particular by releasing or covering the outlet opening (60) of the channel.

The invention relates to a container for dispensing beverage.

Containers for dispensing beverage, wherein a pressure control is provided which keeps the beverage in the inner space of the container relatively constant is known from, for instance, EP 1064221. A beverage container is disclosed therein having in the inner space a pressure control device which comprises a compartment with a pressure medium and a driving device for controlling, on the basis of the pressure prevailing in the inner space of the container, the supply of pressure medium from said compartment in the inner space. With it, each time the pressure in the inner space falls below a desired pressure, an amount of pressure medium can be supplied so that the pressure is returned to the desired value.

With this known container, the driving device alternately opens and closes a valve for releasing said pressure medium. The pressure in the first compartment is relatively low as therein, a material absorbing and/or adsorbing the pressure medium is included.

The object of the invention is to provide a container for dispensing beverage of the type described in the introduction.

In a first aspect, a container according to the invention is characterized in that it is provided with an inner space for receiving the beverage to be dispensed, while a pressure control is provided with a first compartment and a pressure control compartment closed towards the surroundings, the first compartment being provided with an outlet opening with a shut-off, and on the pressure control chamber, driving means being provided for opening and closing the shut-off. A channel is provided which, when in opened position, is in open communication with the first compartment, while the pressure control compartment has a wall part movable relative to the first chamber in an operating direction, which bears an operating element that is slideable in, against or over said channel and can release and seal off an outlet opening of the channel, while the outlet opening terminates directly or indirectly into the inner space of the container. With such a container, the pressure medium can be released if the channel, in particular the outlet opening, is released by the operating element, while dispensing can be stopped in that the channel, in particular the outlet opening, is sealed off by the operating element. Influence of the pressure of the pressure medium in the first chamber on the shut-off can thus be at least partly removed.

In a second aspect, a container is characterized in that the pressure control compartment is provided with means for securing the shut-off in an opened position. As a result, the influence of the pressure of the pressure medium in the first compartment on the opening of the shut-off is eliminated during use.

Preferably, the channel has an outflow direction at the height of the outlet opening which includes an angle with the operating direction, which angle deviates from 180 degrees and is preferably between 30 and 150 degrees, more particularly between 60 and 120 degrees and is preferably approximately 90 degrees. As a result, the influence of the pressure and outflow of the pressure medium on the movement of the movable wall is reduced.

In a further aspect, a container according to the invention is characterized in that the pressure control compartment is included in a first housing which is slideable in the operating direction and is at least partly included in a second housing, which second housing is attached to the first compartment, while fixing/securing means are provided for fixing/securing the first housing relative to the second housing. The first housing can then be moved from, for instance, a non-operative position to an operative position, while in the non-operative position, the shut-off is closed and the movable wall part and the operating element cannot open the shut-off, while in the operative position, the shut-off is opened and is held opened by the first housing, secured relative to the second housing.

In an alternative embodiment, a container according to the invention is characterized in that the shut-off comprises a stem which comprises the channel, wherein the dispensing opening of the channel terminates in a pressure equalizing space of the operating element and can be closed off thereby. With the outlet opening opened, pressure equalizing occurs between the pressure equalizing space and the first compartment, while, when the outlet opening is closed, the shut-off is movable by the respective movable wall part between an opened and a closed position. As a result, the influence of the pressure medium in the first compartment can be compensated such that this has virtually no influence on the opening and closing of the shut-off.

In a further aspect, the invention is characterized in that the container is provided with an inner space for including beverage to be dispensed, while the pressure control is provided with a first compartment and a pressure control compartment closed off to the surroundings, wherein the first compartment is provided with a dispensing opening with a shut-off and driving means are on the pressure control compartment for opening the shut-off through displacement of at least a part thereof in the operating direction, while the shut-off and the drive means are designed for setting approximately the same pressure on two sides of the shut-off located opposite each other in operating direction. As a result, for the displacement of the shut-off in the operating direction only a minimum force is required which is furthermore virtually not dependent on the pressure of the pressure medium in the first compartment.

In yet a further aspect, the invention is characterized by a pressure control device for use in a container according to the invention. Such a pressure control device can be readied outside the container and be attached in or on the container prior to use.

The invention will be further elucidated on the basis of the drawing, in which exemplary embodiments of a container and pressure control device will be described in further detail. In the drawing:

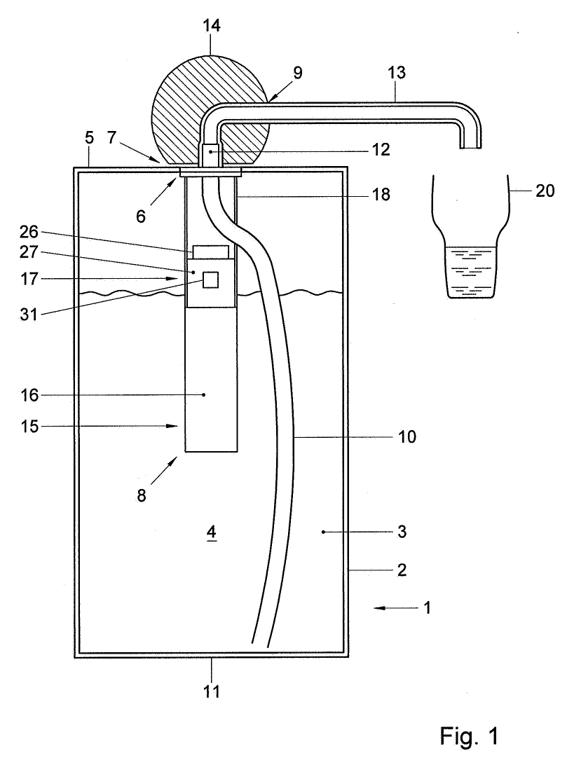

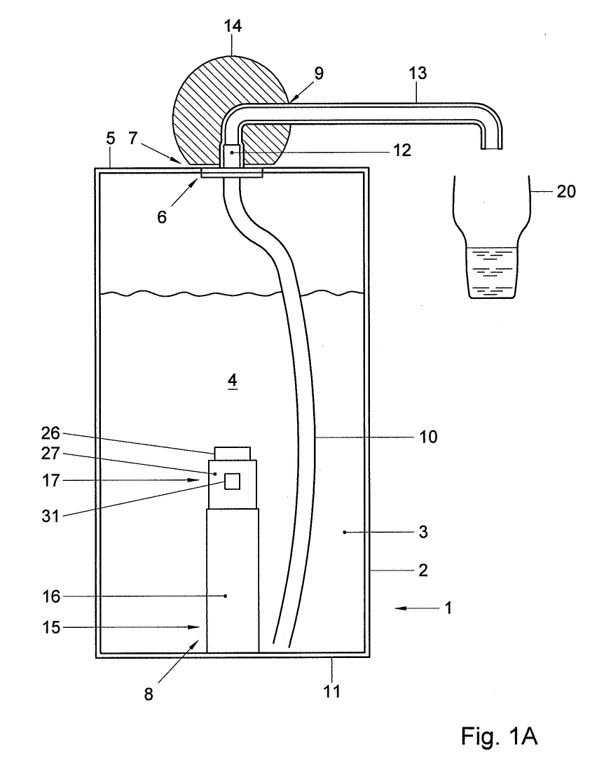

FIG. 1 schematically shows, in partly cross-sectional side view, a first embodiment of a container according to the invention;

FIG. 1A schematically shows, in partly cross-sectional side view, an alternative embodiment of a container according to FIG. 1;

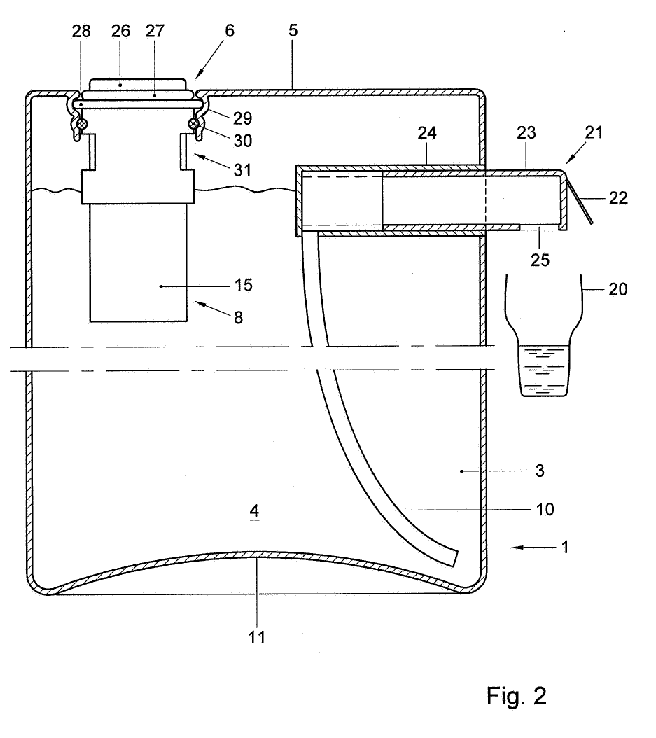

FIG. 2 schematically shows, in partly cross-sectional side view, a second embodiment of a container according to the invention;

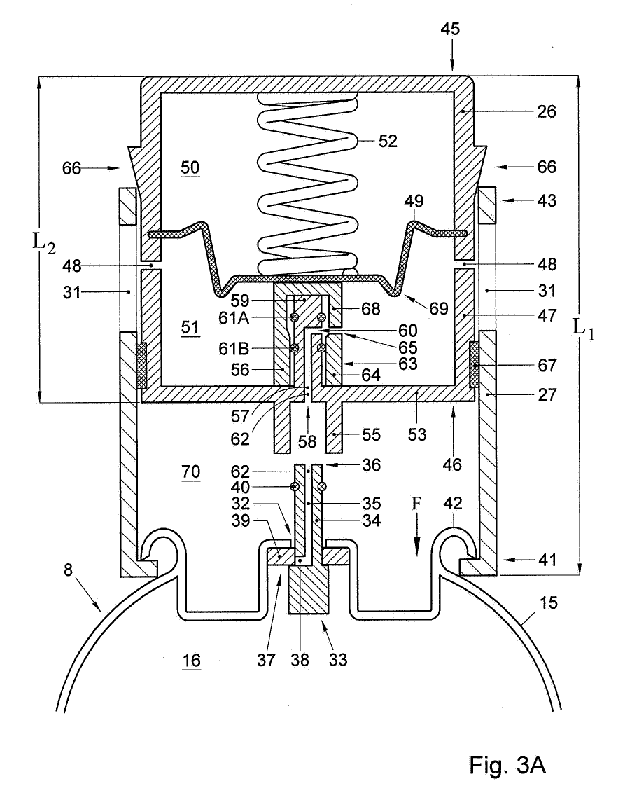

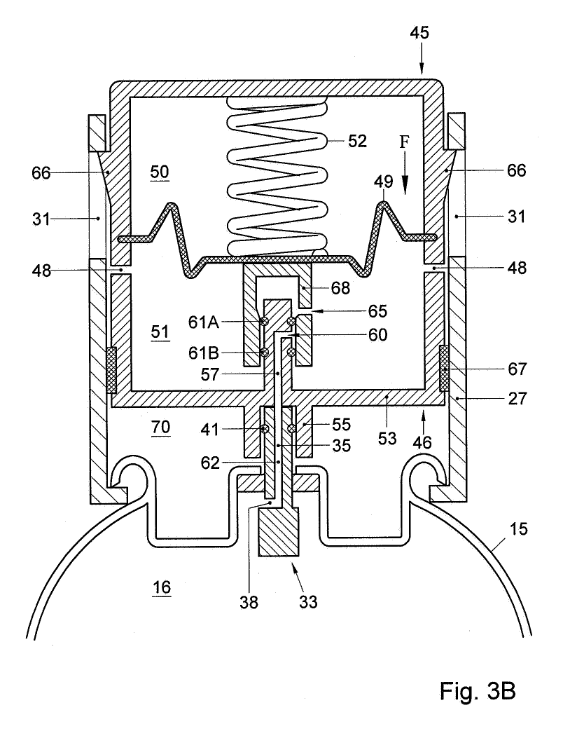

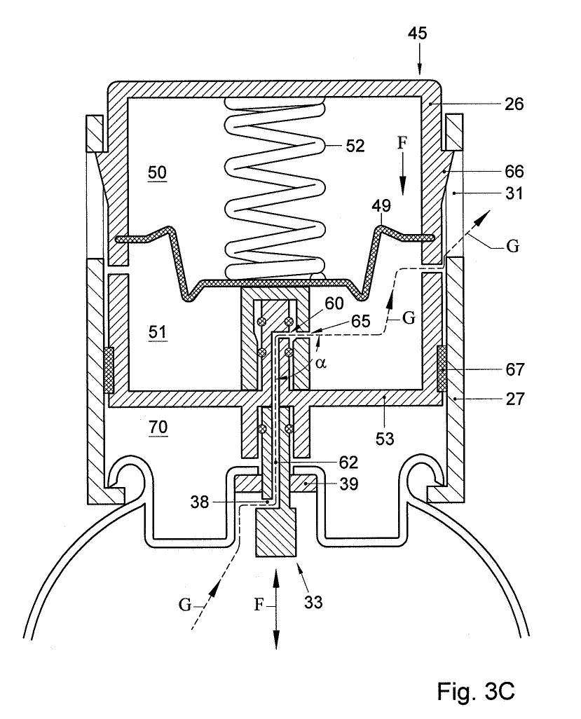

FIGS. 3A-C show, in cross-sectional side view, a part of a pressure control device according to the invention in a first embodiment, in inoperative condition, in operative, closed condition and in operative, opened condition, respectively;

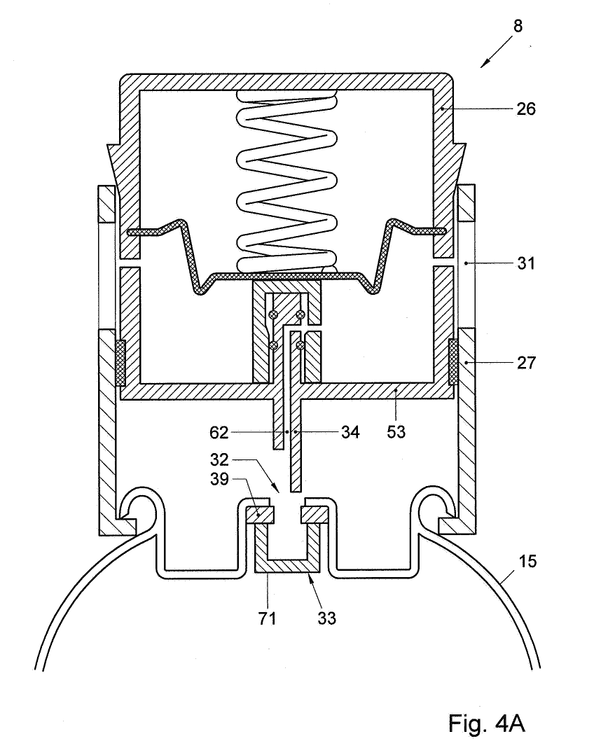

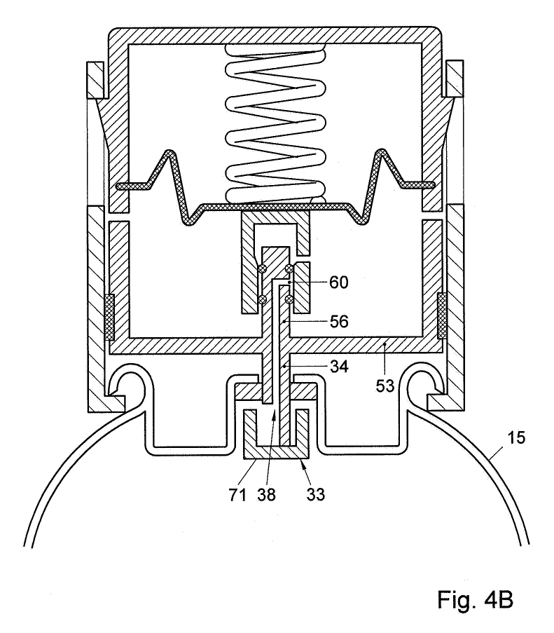

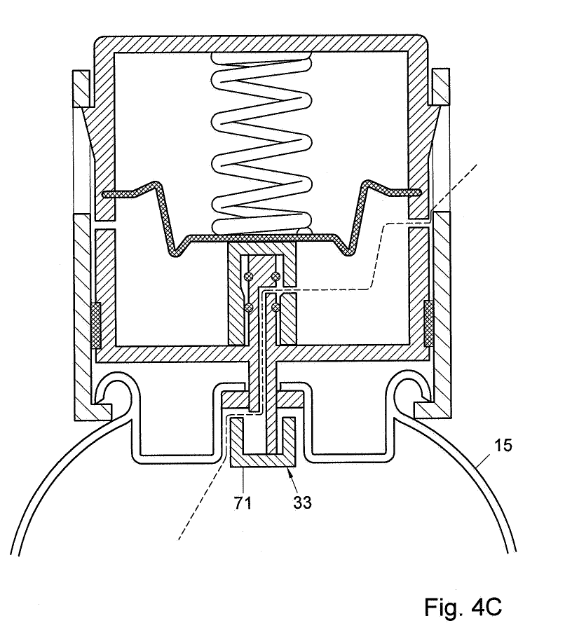

FIGS. 4A-C show, in cross-sectional side view, a part of a pressure control device according to the invention in a second embodiment, in inoperative condition, in operative, closed condition and in operative, opened condition, respectively;

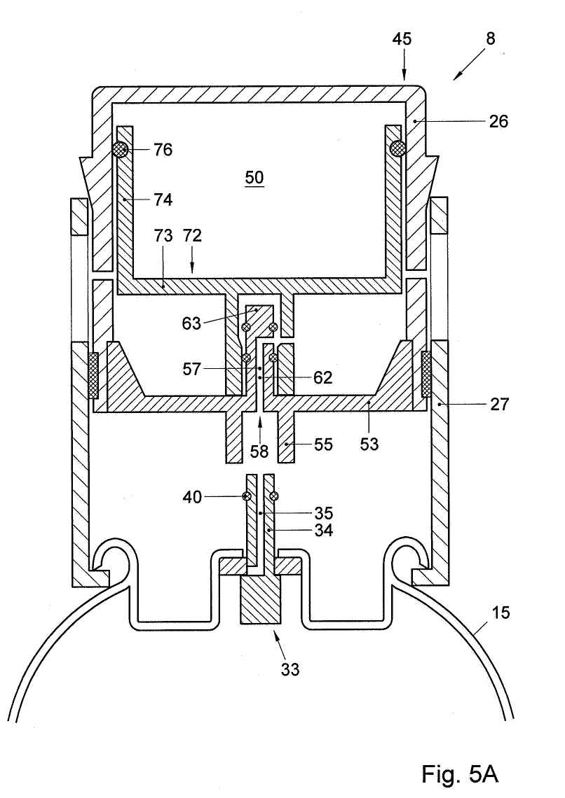

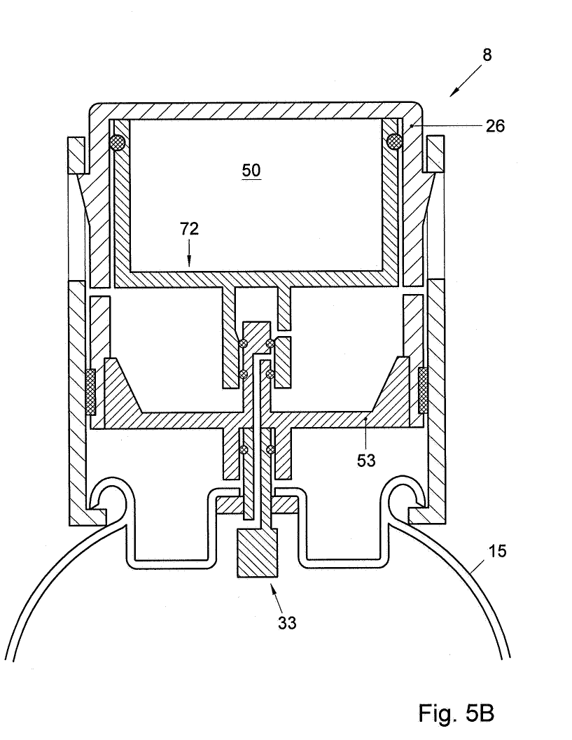

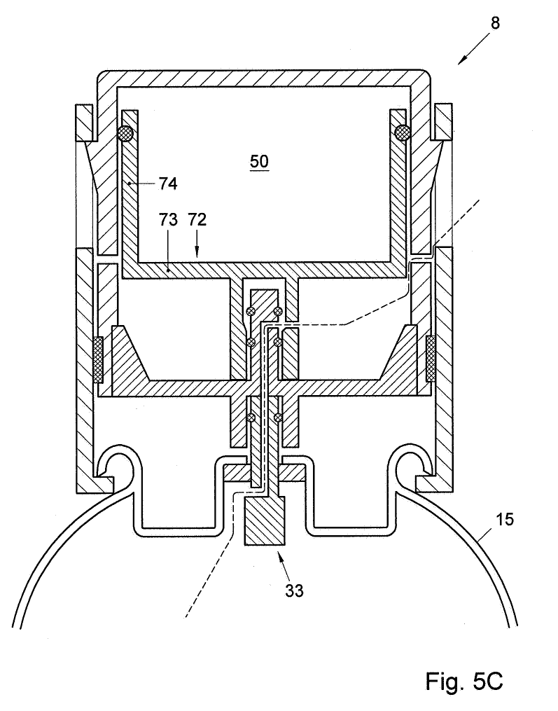

FIGS. 5a-C show, in cross-sectional side view, a part of a pressure control device according to the invention in a third embodiment, in inoperative condition, in operative, closed condition and in operative, opened condition, respectively;

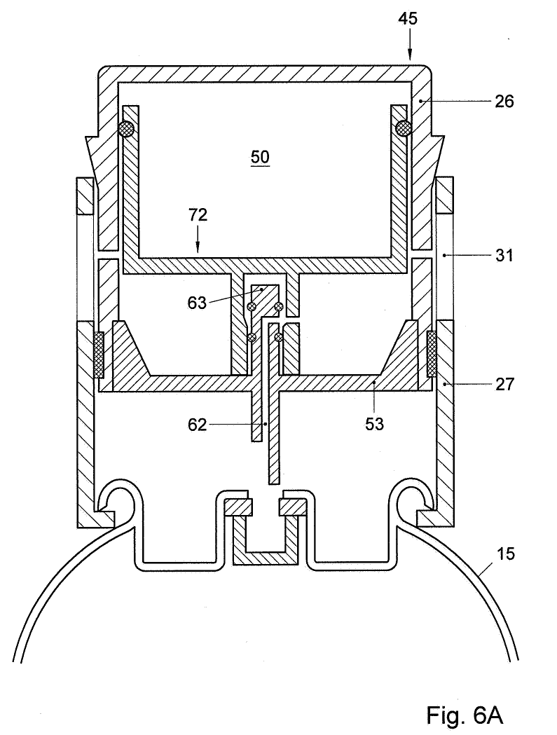

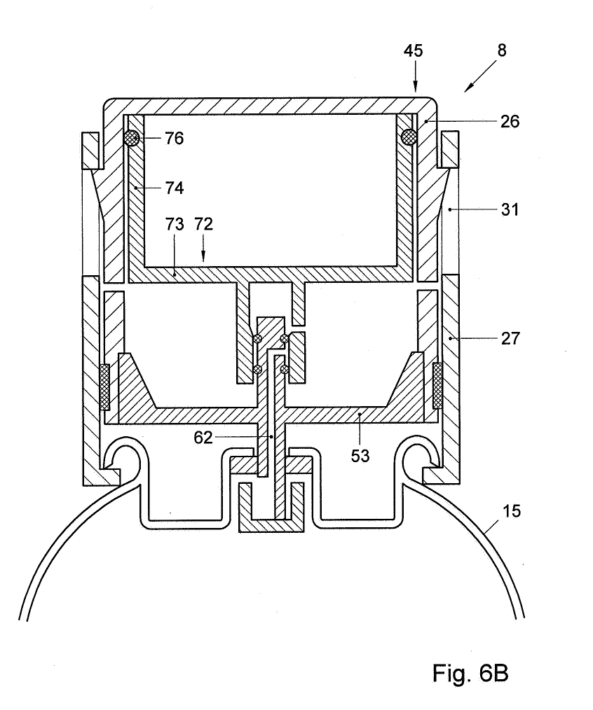

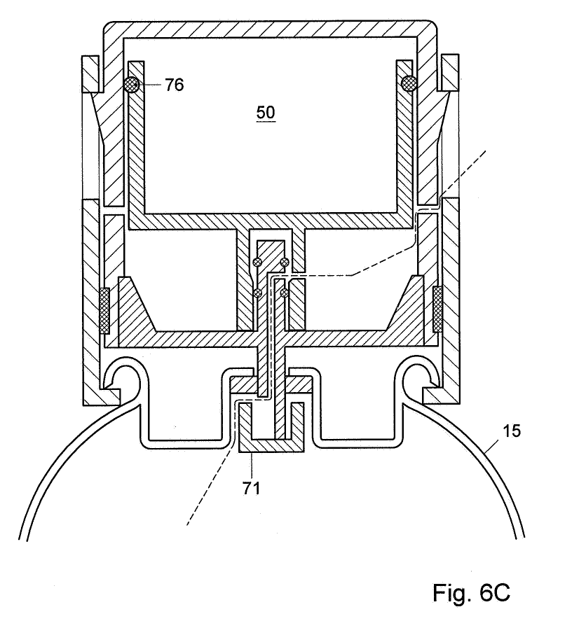

FIGS. 6A-C show, in cross-sectional side view, a part of a pressure control device according to the invention in a fourth embodiment, in inoperative condition, in operative, closed condition and in operative, opened condition, respectively;

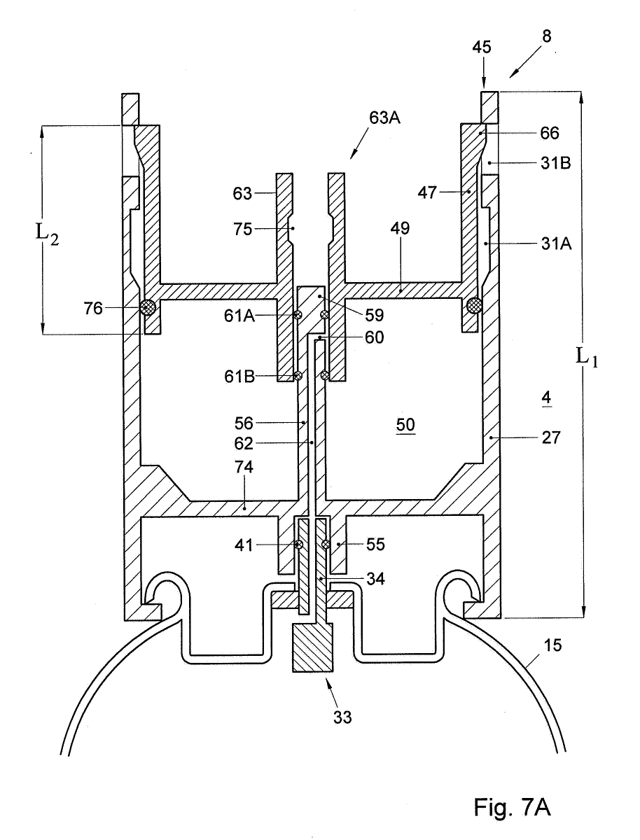

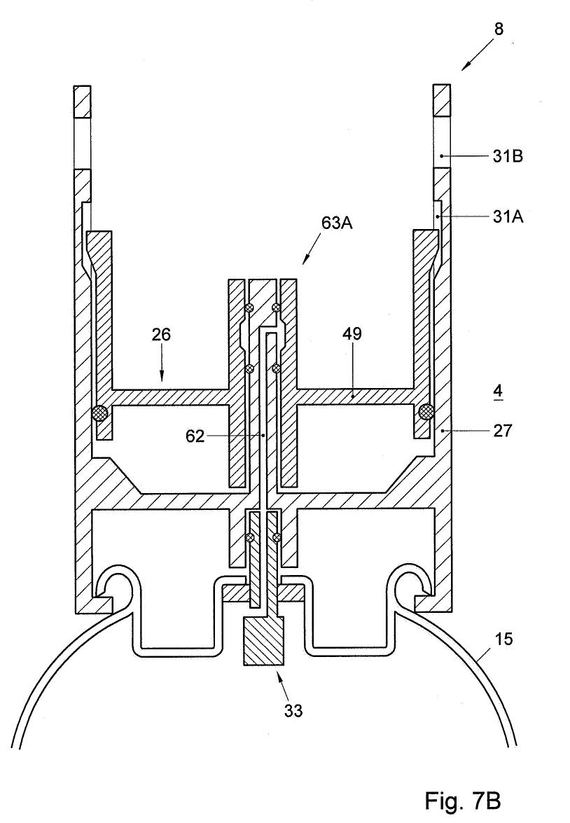

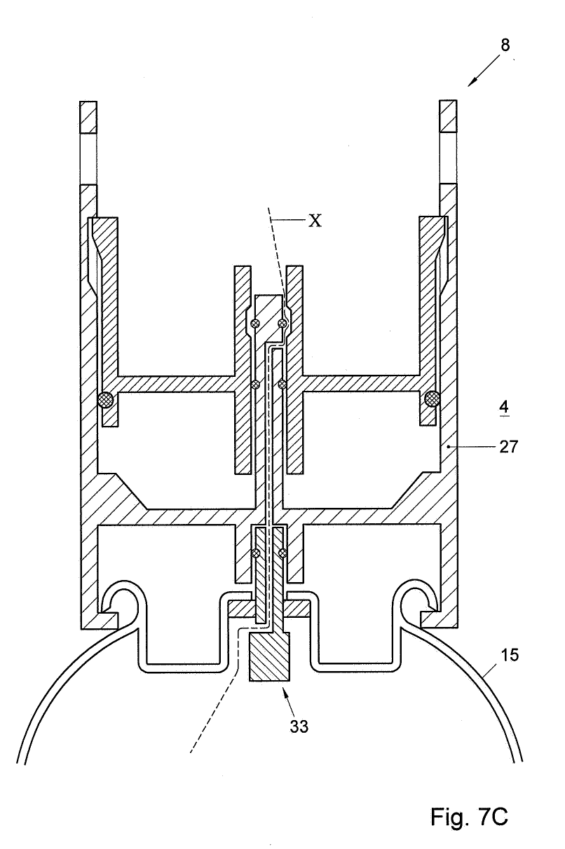

FIGS. 7A-C show, in cross-sectional side view, a part of a pressure control device according to the invention in a fifth embodiment, in inoperative condition, in operative closed condition and in operative, opened condition, respectively;

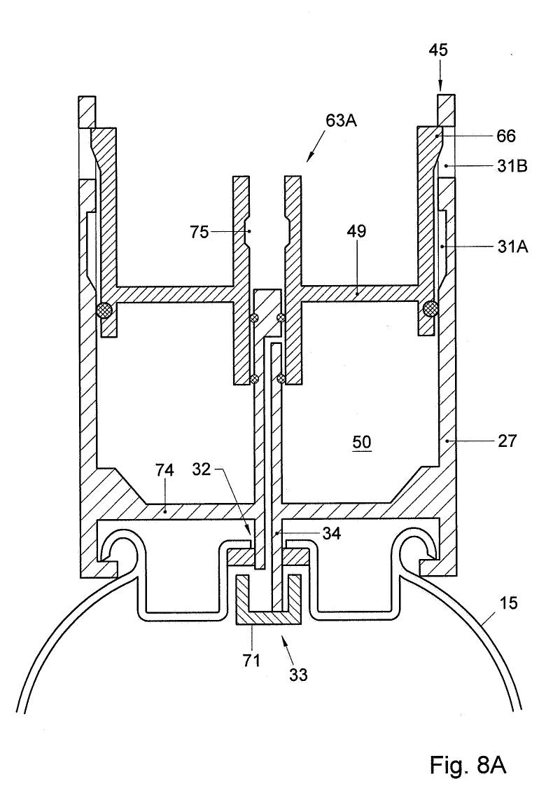

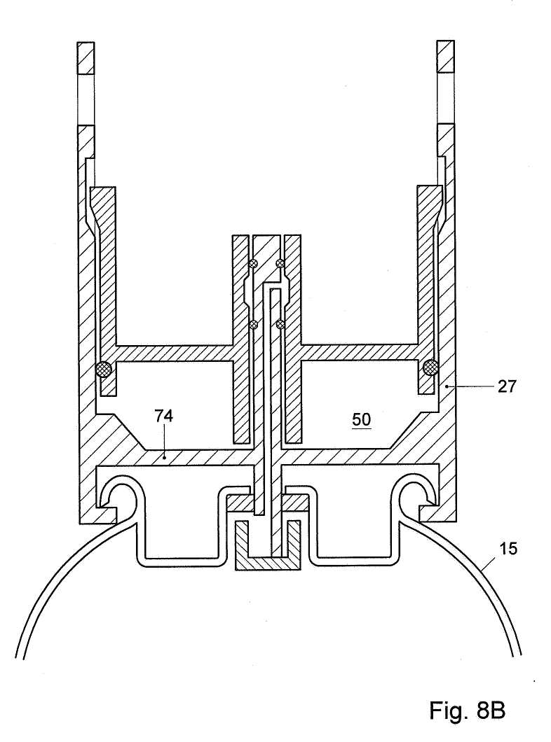

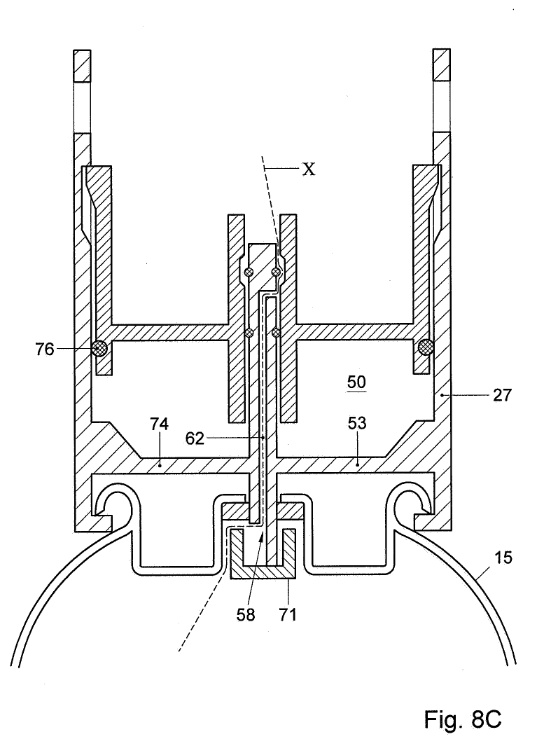

FIGS. 8A-C show, in cross-sectional side view, a part of a pressure control device according to the invention in a sixth embodiment, in inoperative condition, in operative, closed condition and in operative, opened condition, respectively;

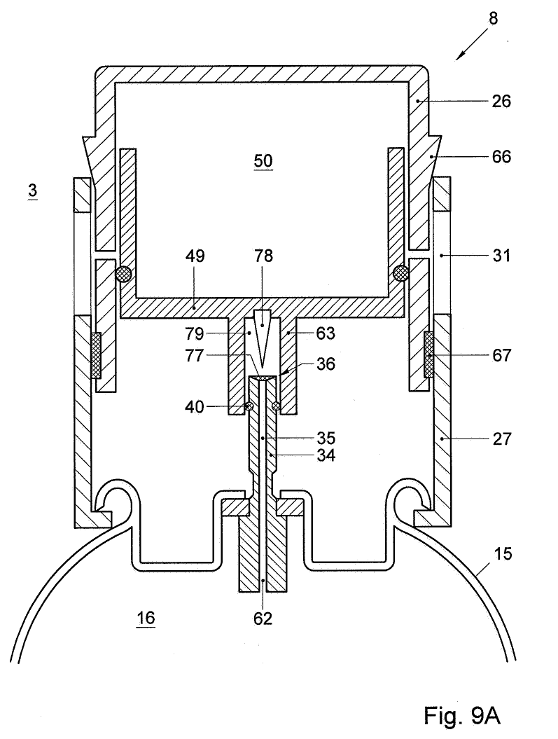

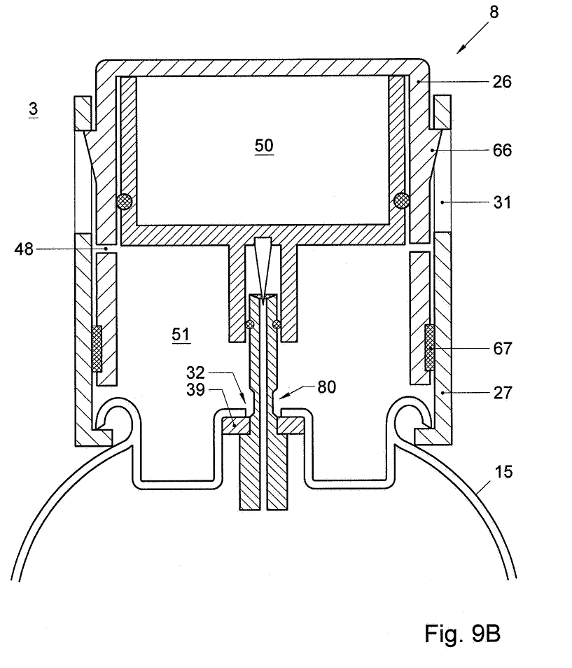

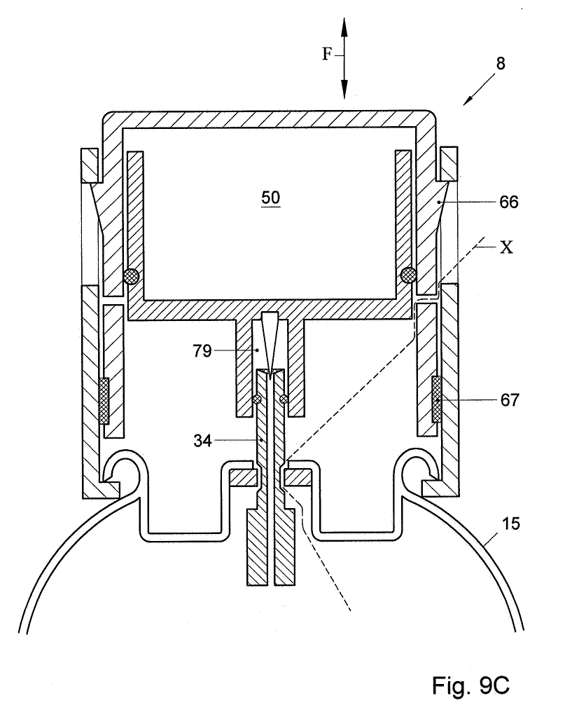

FIGS. 9A-C show, in cross-sectional side view, a part of a pressure control device according to the invention in a seventh embodiment, in inoperative condition, in operative, closed condition and in operative, opened condition, respectively;

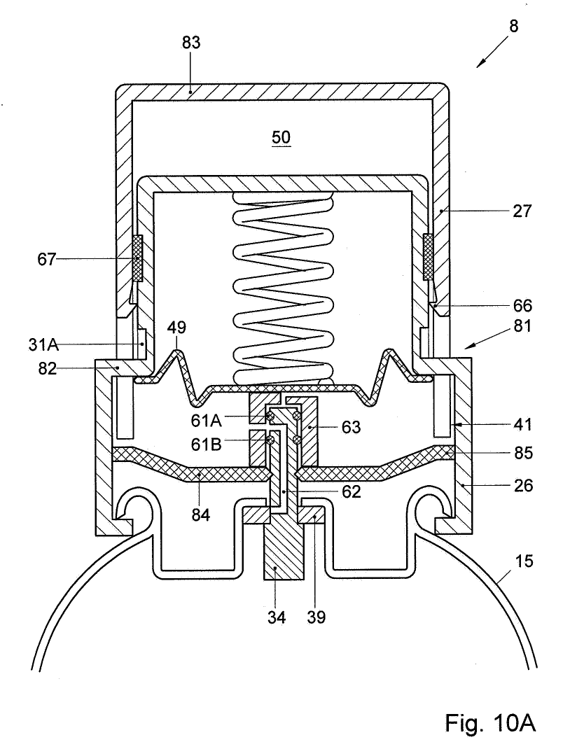

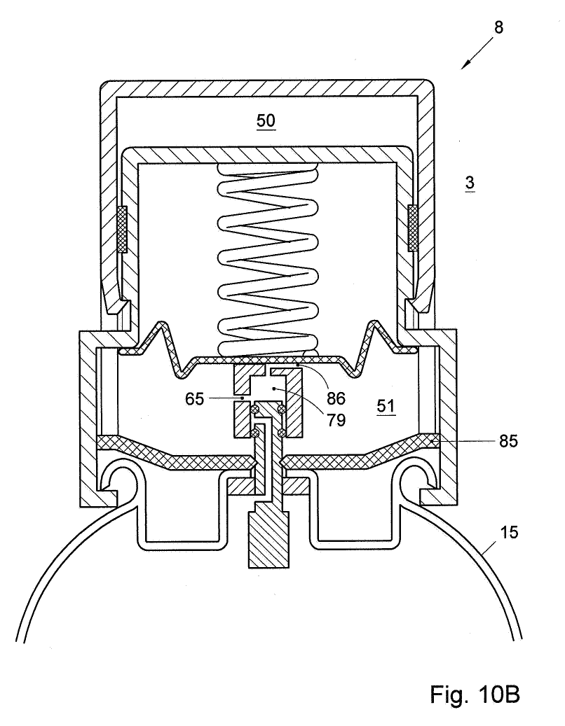

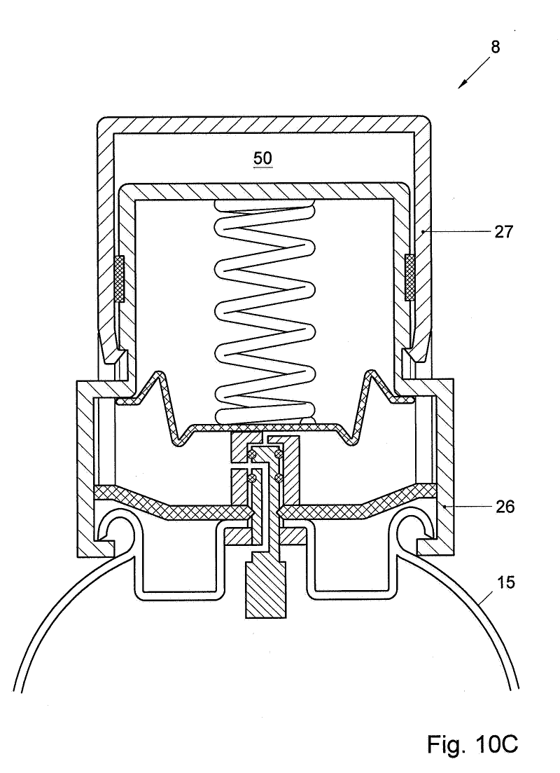

FIGS. 10A-C show, in cross-sectional side view, a part of a pressure control device according to the invention in an eighth embodiment, in inoperative condition, in operative, closed condition and in operative, opened condition, respectively; and

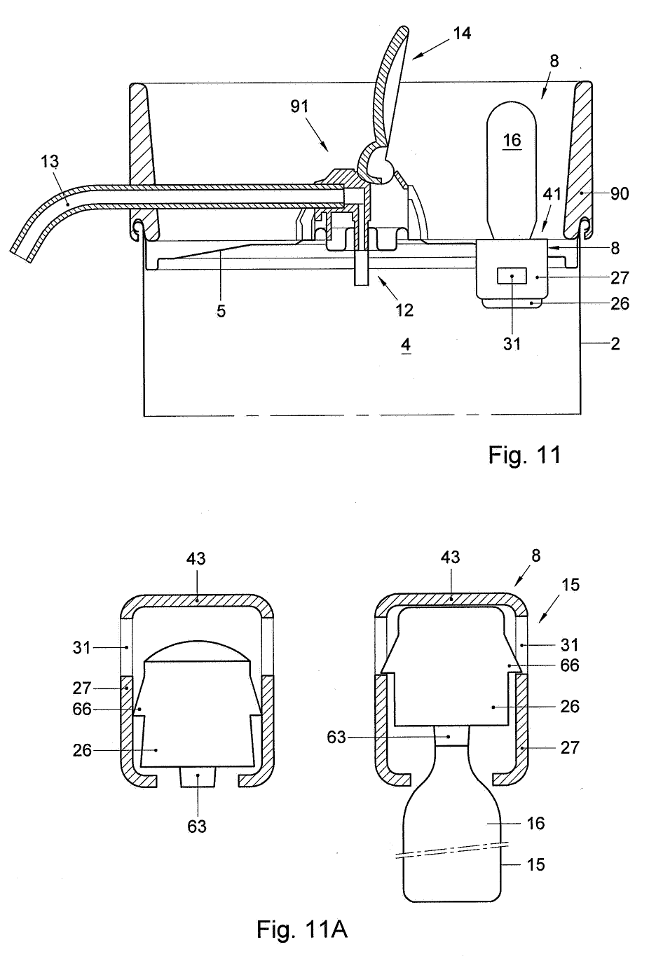

FIG. 11 shows, in partly cross-sectional side view, a further alternative embodiment of a container according to the invention.

In this description, identical or corresponding parts have identical or corresponding reference numerals. The embodiments shown are merely presented by way of illustration of the general inventive concepts and should not be construed to be limitative in any manner. In the description, the starting point will be a container for dispensing carbonated beverage such as beer. However, other beverages too can be dispensed, such as soft drinks or wine.

FIG. 1 is a schematic representation of a device 1 according to the invention, embodied in a container 2 in which an amount of beverage 3 to be dispensed is received. As beverage 3, beer is described, but the invention is not limited thereto. The beverage 3 is received in the inner space 4 of the container 2. The container 2 is represented as a relatively thin-walled can with a content of, for instance, some litres, but can, in fact, have any desired shape, dimension and build-up. In the embodiment shown, the content is for instance between 3 and 6 litres, but can also be used for a smaller content or for more than 10 litres, for instance 25, 30 or 50 litres. As is customary with such containers, the inner space 4 is sealed off towards the surroundings, in order to prevent contact between the beverage 3 and the surroundings. Dispensing means 7 to be further described are provided for dispensing the beverage 3. In FIG. 1, these are provided in an opening 6 in the upper surface 5 but these can also be provided at a different position or in a different surface, for instance in a sidewall. In the inner space 4, further, a pressure control 8 is provided, in this embodiment suspended from the dispensing means 7, but it can also be attached to, for instance, the bottom 11 of the container 2, as shown in FIG. 1A, or be provided in a different manner. In principle, it can even be provided separately in the beverage 4 or as a fixed part of the container 2. A dip tube 10 is provided which reaches from the dispensing means 7 to a point adjacent an edge of the bottom 11, so that all beverage 3 can be dispensed.

In the embodiment shown, the dispensing means 7 comprise a dispensing duct 13 which reaches from a lid or other valve 12 to a point beyond the outer circumference of the upper surface 5, and is formed such that a glass or other holder 20 can be held under an outlet opening thereof. The dip tube 10 is connected to the valve 12. An operating knob 14 is provided with which the duct 13 can be moved downwards such that the valve 12 is opened and beverage can be dispensed under pressure from the inner space 4 into the glass 20. Such a set up of a container is known from, for instance, EP1064221 and is put on the market by applicant under the name Draftkeg.

In this Draftkeg, the pressure control is provided in the form of a first compartment filled with activated carbon, further comprising an amount of CO₂ gas which is absorbed and adsorbed for the larger part by said activated carbon. As a result, the pressure of the CO₂ gas is relatively low, while still, sufficient gas can be included for urging all beverage 3 from the inner space 4. The pressure control is provided with driving means with which the pressure in the inner space is automatically held at a desired driving pressure while beverage is dispensed. Thus, this known device has the advantage that no external pressure means are required. However, as the case may be, including activated carbon may be less appealing. It can, for instance, be expensive, technically complicated, the activated carbon may lead to contamination and waste problems and, furthermore, the release of the gas by/through the activated carbon may be too sensitive to the temperature of the pressure control in general, and of the gas and the carbon in particular. A further drawback may be that the pressure control, in particular the first compartment in which the gas is included, will still be relatively large. A further drawback of this known pressure control is that it is less suitable for high pressures in the first compartment because then, the driving behaviour will be undesirably influenced by the pressure in the first compartment and, in particular, by changes therein as a result of the fact that the gas pressure acts on the driving means.

With a device according to the invention, a pressure control 8 is used which is considerably less sensitive to high pressures and, in particular, to pressure changes during use. Furthermore, no activated carbon or similar gas absorbing and/or adsorbing means needs to be used therein, although this is possible, with the earlier described advantages of lower pressure with the same volume of gas in a compartment of the same volume. Embodiments of a pressure control according to the invention will be described in further detail on the basis of FIGS. 2-11 and each have, for instance, a body 15 with a first compartment 16 and pressure control means 17 fulfilling the function of driving means for dispensing gas from the first compartment 16 in a controlled manner, as will be described in further detail. In FIG. 1, the body 15 is suspended from the dispensing means 7 with the aid of suspension means 18. Preferably, the dispensing means 7 can be introduced with the pressure control 8 through the opening 6, whereupon the opening 6 is sealed off by the dispensing means 7, or is placed on, for instance, the bottom 11 before the container is closed.

In FIG. 2, schematically, an alternative embodiment of a device 1 according to the invention is shown, once more designed as a container 2, for instance a steel or plastic container, while the dispensing means 7 comprise a tap 21, as known from, for instance, WO 99 31010, WO 0007927 or WO 2006/000437 or such as used in practice in beer cans for dispensing beverage under the influence of gravity. Many variations thereon are possible within the invention, while a tap 21 can be provided at any desired position. Before use, the tap 21 can be included virtually completely in the inner space 4 of the container 2, as indicated by the interrupted lines in FIG. 2. By pulling the lip 2, the inside portion 23 of the tap 21 is pulled from the housing 24 and a dispensing opening 25 is released, while furthermore, the dip tube 10 enters into open communication with the dispensing opening 25 through which beverage can be dispensed.

In the embodiment shown in FIG. 2, the pressure control 8 is suspended in an opening 6 in the upper surface 5 of the container 2, such that the opening 6 is complexly sealed off thereby. The reference numerals in FIGS. 1 and 2, insofar as not mentioned and discussed hereinabove, are discussed in further detail on the basis of FIGS. 3-10. What is shown is an embodiment wherein the pressure control 8 comprises a body 15 in which the first chamber is included, as well as a first housing 26 and a second housing 27. The second housing 27 surrounds the first housing 26 at least partly and is attached to the body 15. The second housing 27 is provided adjacent the side remote from the body 15 with a ridge 28. The opening 26 comprises an edge 29 which reaches into the inner space 4 and in which the ridge can be fittingly, and preferably clampingly, and more particularly sealingly received, so that the opening 6 can be sealed off. Optionally, a gasket 30, for instance a plastic or rubber ring, a seal such as a glue connection or other shut-off can be provided between the second housing and the edge 29 in order to obtain a gastight connection. In the second housing 27, two openings 31 are provided, below the gasket 30, the purpose of which will be explained further. The first housing 26 is accessible from the outside of the container 2, for instance by hand or by an instrument, for putting the pressure control in operation, as will be explained in further detail.

It is noted that each of the pressure devices 8 shown in FIGS. 2-10 and variants thereon can be used in a device according to the invention, of which examples are shown in FIGS. 1, 1A, 2 and 11. In FIGS. 3-10, each time schematically, a part of a pressure control is shown in cross-sectional side view, while each time, a condition prior to a first use (A), a condition directly after putting in operation or in rest after operation (B), and a condition when gas is supplied from the first chamber (C) is represented, indicated as “inoperative condition” “operative closed condition” and “operative open condition”, respectively. With each embodiment shown, the first compartment 16 is filled, at least at the start of use, with pressurized gas, in particular CO₂, preferably at a relatively high pressure, i.e. compressed, for instance initially at a pressure of more than 5 bars in gas phase, more particularly between 10 and 20 bar in gas phase, or, for instance, more than 30 bars, for instance approximately 50 bars in liquid condition, at a temperature of 20° C. When a gas adsorbing and/or absorbing material such as activated carbon, zeolite or the like is used in the pressure container, the pressure may be lower or more gas can be introduced. In the description, this will be the starting point, unless expressly stated otherwise. There where, in this description, a valve is described, it should be understood that any type of valve can be utilized that can be operated by the driving device between an opened and a closed position. It is preferred that in closed condition, the valve is biased.

In FIGS. 3A-C, a part of a pressure control 8 is shown, provided with the body 15 with the first compartment 16. A dispensing opening 32 is provided in the body 15, in which a valve 33 is provided that seals off the dispensing opening 32. In the embodiment shown, the valve 33 is designed as a male valve, which means that a stem 34 reaches from the valve 33 to a point beyond the body 15. A first channel part 35 extends from an open first end 36 through the stem 34 and is bent-over at the opposite, second end 37 such that an inlet opening 38 is provided in a side of the stem 34. Around the stem 34, in the first compartment 16, a shut-off 39 is provided which, with the valve 33 in the closed position shown in FIG. 3A, seals off the inlet opening 38. Spring means (not shown) ensure a bias on the valve in this closed position. Such a valve 33 is sufficiently known per se and is generally used in, for instance, aerosol containers. By moving the stem 34 against the bias, in an operating direction F, in the direction of the first compartment 16, the inlet opening 38 is released below the shut-off 39 so that an open communication is obtained between the first compartment. This opened condition is shown in FIGS. 3B and C. On the outside of the stem 34, adjacent the first end 36 a gasket 40 is provided, for instance an O-ring.

The second housing 27 is substantially cylindrical with an axial first length L1 and is secured by a lower end 41 on the body 15, for instance below a curled edge 42, securing the valve 33 to the housing in a customary manner. As a result, the housing cannot move relative to the body 15. Adjacent a longitudinal edge 43 located opposite the lower end, two openings 31 are provided, for instance diametrically opposite each other. The first housing 26 is also substantially cylindrical, with an axial length L2, but is closed at the two opposite ends 45, 46. In the longitudinal wall 47 of the first housing a number of preferably relatively small openings 48 are provided, in FIG. 3A, at, for instance, the height of the openings 31. A wall part 49 divides the inner space of the first housing 26 into two spaces separated substantially transversely to the axial direction. On the side of the wall part 49 remote from the body 15 a pressure control compartment 50 is provided, on the opposite side a connecting space 51 into which the openings 48 terminate. In this embodiment, the wall part 49 is designed as a membrane, manufactured from, for instance, plastic or metal, and deformable. Between the wall part 49 and the end wall 45 remote from the body, a spring element 52 is provided in the shape of a compression spring, which biases the wall part in the direction of the valve 33.

The end 46 of the first housing 26 proximal to the valve 33 is formed by an intermediate element 53 which may be manufactured in one piece with the first housing 26 or can be provided as a lid. On the side proximal to the valve 33, on the intermediate element 53, an element 55 is provided in the form of a substantially cylindrical bush which fits over the stem 34 and the shut-off 41 for obtaining a gastight connection. On the opposite side, on the intermediate element, a second stem 56 is provided. This extends preferably coaxially to the earlier mentioned stem 34. A second channel part 57 extends through the second stem 56, from an end 58 proximal to the valve 33 in the direction of the opposite end 59, at which location a bend is provided in the channel part 57, so that an outlet opening 60 is provided in a side of the second stem 56, slightly below the adjacent end 59. Around the outside of the second stem 56, two gaskets 61A, 61B are provided, for instance two O-rings, one on each side of the outlet opening. The first channel part 35 and the second channel part 57 extend in line such that in operative condition (FIGS. 3B and C) they form a continuous channel 62.

On the side of the wall part 49 proximal to the valve 33, an operating element 68 of the operating means 69 is provided, in the shape of a substantially cylindrical bush 63 that fits over the second stem 56 and the two gaskets 61A, 61B, by sliding it over them, in axial direction of movement or direction of operation F. In the wall 64 of the bush 63 an opening 65 is provided in a position such that in operative, open position (FIG. 3C) and, optionally, in the inoperative position (FIG. 3A) it is at the location of the outlet opening 60, which is understood to mean that it is positioned such that in that condition, there is an uninterrupted stream path between the channel 62 and the connecting space 51, while in the operative, closed condition (FIG. 3B), the opening 65 is farther from the valve than one of the two gaskets 61A, 61B which is farthest from the valve 33. The space in the bush 63 between the wall part 49 and the end 59 of the second stem 56 then preferably enters into open communication with the connecting space 51 while pressure equalization occurs.

The first housing 26 is provided on the outside with protrusions 66 which, in the inoperative position (FIG. 3A), are on or above the upper longitudinal edge of the second housing 27 but which, in the operative position, are included in the openings 31 such that they hook therein and prevent further axial movement of the first housing 26 relative to the second housing 27. Between the outside of the first housing 26 and the inside of the second housing 27, adjacent or around the intermediate part, a sliding shut-off 67 is provided so that the space 70 between the second housing 27 and the body 15 is sealed off in the direction of the openings 31. A comparable gasket can be provided adjacent the upper peripheral edge of the second housing, beyond the openings 31. This is of importance in particular with an embodiment according to FIG. 2, because thus, gas is prevented from flowing away to the surroundings.

A pressure control 8 according to FIG. 3 can be used as follows.

In the pressure control chamber 50 an ambient control pressure P₀ prevails, which, together with the spring pressure of the spring 52 exerts a Pressure P_{control} on the wall part 49, in the direction of the valve 33, that is, the operating direction F. In the first chamber 16, at the start of use, a maximum gas pressure P₂ prevails, for instance 12 to 16 bars, as a result of an amount of compressed gas therein, such as pure CO₂. In the connecting space 51, a pressure P1 prevails which is, for instance, equal to the pressure P₀ in the pressure control compartment 50. The first housing 26 is in the inoperative position as shown in FIG. 3A, while the intermediate part 53 and in particular the bush 55 are at a distance of the first stem 34 and, hence, the valve 33 is and remains closed.

Then, from the inoperative position shown in FIG. 3A, the first housing 26 is pressed in the operating direction F in axial direction towards the valve 33, so far until the protrusions, designed as, for instance, snap fingers, engage into the openings 31 and prevent the first housing 26 from moving back. Here, the bush-shaped element 55 is slid over the first stem 34 and the gasket 40, thus forming the channel 62. As a result of this movement, the valve is opened while the axial confinement of the first housing within the second housing ensures that the valve 33 remains opened.

In the embodiment shown in FIG. 1, moving the first housing from the inoperative position (FIG. 3A) to the operative position (FIGS. 3B and 3C), can be done by increasing the pressure in the inner space 4 of the container 2 to such an extent that the first housing is pressed inside the second housing and the fingers 66 engage in the openings 33. This may for instance be done by injecting a small amount of CO₂ gas into the inner space, via the opening 6. In the embodiment shown in FIG. 2, this can be done by, for instance, depressing the first housing 26 with a finger or a tool until the fingers 66 engage in the openings 31. Optionally, also other means can be provided for moving the first housing into the operative position, for instance cooperating screw thread on the outside of the first housing and the inside of the second housing.

In the operative position as shown in FIGS. 3B and 3C, the channel 62 extends between the opening 38 which is always opened and is therefore in open communication with the high gas pressure P₂ and the outlet opening 60, which, in closed position (FIG. 3B) is sealed off by the wall 64 of the bush 63 and the two gaskets 61A, B. The pressure P₁ in the connecting space 51 is each time equal to the pressure in the inner space 4 of the container 2. In a position of equilibrium, this pressure P₁ will be approximately equal to the desired control pressure, for lager type beer for instance between 1.7 and 2.1 bars, at approximately 6° C., while it is preferred to control on the equilibrium pressure for CO₂ in the beverage. The pressure P_{control} which is exerted from the pressure control compartment 50 on the wall part 49 will then be in equilibrium with the pressure exerted from the connecting space 51 (the pressure P₁ prevailing therein) on the wall part 49, whereby the wall part is brought into an intermediate position as shown in FIG. 3B, so that the outlet opening 60 is sealed off in the earlier described manner. When beverage 3 is tapped from the inner space 4 of the container, which beverage is urged away by the pressure P1 when the shut-off 12 or the tap 21 is opened, then, the pressure P1 in the inner space will decrease, so that the movable wall part 48 is urged in the direction of the valve, in the operating direction F, thereby sliding the bush 63 so far over the second stem 56 until the outlet opening 60 is released at the location of the opening 65, as shown in FIG. 3C, so that gas under high pressure P₂ can flow out into the connecting space 51 and from there into the inner space 4. As a result, the pressure in the inner space 4 and the connecting space 51 increases again, thereby urging the wall part 49 back to the position of equilibrium as shown in FIG. 3B, so that the supply of gas under high pressure is stopped. In this way, the pressure in the inner space 4 is automatically maintained at approximately the control pressure.

The high gas pressure P₂ and/or the closing pressure of the valve 33 hardly influence, if at all, the movements of the wall part 49 or the opening of the valve 33. With the embodiment show, this is at least achieved in that the outflow opening G of the gas from the outlet opening includes an angle α with the operating direction F and/or the longitudinal axis and/or the axial direction of the first and second housing 26, 27. As a result, high pressure can be used and change in the pressure P₂ in the first compartment 16 through, for instance, decrease of the amount of available gas during the dispensing time of the beverage has no influence on the tapping behaviour or on the optional CO₂ content of the beverage.

In FIGS. 4A-C, an embodiment is shown of a pressure control which is comparable to that according to FIG. 3. Basically, only the differences will be discussed. A female valve 33 is used instead of a male valve. With a female valve, the (first) stem 34 is not connected to the valve 33 but to an operating device, such as the intermediate element 53. The valve 33 comprises a tray-shaped part 71 under the opening 32 which is pressed by, for instance, a spring (not shown) and/or the gas pressure P₂ with a longitudinal edge against a shut-off 39 and can be pressed therefrom with the aid of said stem 34, so that an open communication between the channel 62 in the stem 34 and the first compartment is obtained. Such female valves are generally known. With this embodiment, the first stem 34 extends from the side of the intermediate element 53 proximal to the valve 33, in line with the second stem 56, so that a continuous channel 62 is obtained with inlet opening 38 and outlet opening 60 as earlier described, the bend in the channel at the inlet side of the first stem 34 being omitted. In this embodiment, the first stem 34 is pressed through the opening 32 and into the part 71, so that this part of the shut-off 39 is pressed shut and held shut. Then, in the earlier described manner, the pressure in the inner space can be controlled.

In FIGS. 5A-C and FIGS. 6A-C, a pressure control 8 with a male and a female valve, respectively, is shown, which differs from the embodiments shown in FIGS. 3 and 4, respectively, in particular in that the wall part 49, that was designed as membrane, has the shape of a piston 72 here, while here, the intermediate element 53 is provided as separate part in the underside of the first housing although this may also be a fixed part, for instance a welded or glued lid. The piston 72 has a bottom wall 73 and a circumferential wall 74 which extends to the side remote from the valve 33 and is provided at the outside with a shut-off 76 which can glidingly seal against the inside of the first housing 26. Between the piston 72 and the first housing 26, again, a pressure control compartment 50 is confined. The stroke of the piston 72 is preferably bound in the direction away from the valve by the upper end 45 of the housing 56, and downward, by the intermediate part 53 and/or the second stem 63.

In FIGS. 7A-C and FIGS. 8A-C, further variants of a pressure control according to the invention are shown, again for a male and a female valve 33, respectively. With this embodiment, the second housing 27 is provided with a wall 74 extending approximately transversely to the longitudinal axis of the housing 27, adjacent the valve 33, and is provided with a bush 55 which fits over the stem 34 and gasket 41 of the male valve 33 (FIG. 7) or is provided with the first stem 34 which extends downwards and reaches through the opening 32 into the part 71. With this embodiment, the valve 33 is therefore opened and held opened by the second housing. The second stem 56 extends in opposite direction over a relatively great length with respect to the axial length L₁ of the second housing and L₂ of the first housing 26, and comprises the channel 62. The channel 62 has approximately the same shape as that according to FIGS. 3 and 5 or 4 and 6, respectively. Around the second stem 56, adjacent the free end 59, again, two gaskets 61A, 61B are provided, on opposite sides of the outlet opening 60.

In this embodiment, the first housing 26 has a circumferential wall 47 with a transverse wall 49 forming a moving wall part. The transverse wall 49 is provided in its center with a bush 63 with a substantially cylindrical shape, open to both sides, which extends coaxially to the first stem. Adjacent an end 63A remote from the valve 33, the bush 63 is provided on the inside with a widening 75, and fits over the second stem 56 and the gaskets 61 such that a gliding shut-off is obtained, except when one of the gaskets 61, in particular the gasket 61 located farthest from the valve 33 is located in the widening 75. With the aid of a gasket 76, the first housing seals in a gliding manner against the inside of the second housing 27 and forms, in fact, a piston.

Between the transverse wall 49 and the first housing 26 functioning as piston, a pressure control compartment 50 is included. Therein, during use, in a condition of equilibrium, a control pressure P3 prevails while in the inoperative position (FIG. 7A, 8A respectively) the pressure prevailing therein is approximately atmospheric, or at least lower than the control pressure. When bringing the pressure control to the operative position, gas present in the pressure control chamber 50 is compressed, so that the control pressure is brought about. As clearly appears from FIGS. 7B and 8B, in the operative closed position, the widening 75 is brought to the height of the outlet opening 60, between the two gaskets 61A, 61B, so that no gas can flow from the outlet opening to the surroundings, in particular to the inner space 4 of the container 2.

Adjacent the upper longitudinal edge 45, the second housing is provided with cavities 31A, which fulfils a function comparable to that of the openings 31 in the previous Figures, but which allow a slight axial sliding, as will be described in further detail. Furthermore, between the longitudinal edge 45 and the cavities 31A, openings 31B are provided, in which the protrusions such as fingers 66 of the first housing 26 can engage when the pressure control is in the inoperative position, as shown in FIGS. 7A and 8A. In the operative, closed position, as shown in FIGS. 7B and 8B, the pressure P₁ prevailing in the container 2, which is at least equal to approximately the desired control pressure (for instance approximately 1.4-2.3 bar for a lager beer) exerts pressure on the wall part 49, which pressure at least equals the pressure in the pressure control chamber 50. As a result, the first housing 26 is pressed maximally in the direction of the valve, in which condition the outlet opening 60 as described is screened off from the surroundings. When beverage is discharged from the inner space 4, or the pressure therein is reduced for other reasons, for instance when cooling, the pressure on the wall par 49 will decrease from the side remote from the valve, so that the first housing 26 is pressed away from the valve at most until the protrusions 66 run against a longitudinal edge of the openings, at least cavities 31A, as shown in FIGS. 7C and 8C. As a result, the passage X through the channel 62 from the first compartment to the inner space of the container is released, via the widening and the end of the bush.

It will be clear that instead of a valve 33, also a different type of shut-off can be utilized, for instance a stop to be opened once only, which can be pressed into the first compartment and remains closed due to the gas pressure until the control is brought to the operative position, or a pierceable shut-off, for instance a seal, stop or membrane. As body with a first compartment, also, a commercially available CO₂ cartridge can be used such as used in, for instance, whipped cream cans, soda water and the like, which cartridge could simply be screwed into the second housing, for instance from the bottom against stem 34 and can be pierced in an earlier described manner.

With a control as shown in FIGS. 7 and 8, the first compartment can already be opened in the brewery, for instance by pressing-in a valve, piercing or the like, while the control chamber is only pressurized upon use, as a result of the location of the control chamber and the piston.

FIGS. 9A-C show a further elaboration of a pressure control 8 according to the invention, somewhat comparable to the one according to FIGS. 5A-C, while, however, the intermediate element 53 is omitted. With this embodiment, prior to use, the channel 62 in the first stem 34 is sealed off at the second end 36, for instance by a pierceable seal 77. The channel reaches into the first compartment 16. In the bush 63 which is provided on the wall part 49, which wall part 49 is, once more, designed as a part of a piston, a needle 78 or similar sharp element is provided which, in the inoperative position (FIG. 9A) of the driving device, is located at a distance of the seal 77. When the first housing 26 as earlier described is brought into the operative position (FIGS. 9B and C) the needle 78 is pressed through the seal 77. In the operative, closed position (FIG. 9B), the needle is somewhat retracted relative to the operative, open position (FIG. 9C) so that in the closed position, gas can flow under high pressure P₂ from the first compartment 16 via the channel 62 into the space 79 confined in the bush 63. As a result, pressure equalization occurs and the gas presses approximately equally hard at both ends of the stem 34. This means that when the pressure P₁ in the connecting space 51 (and hence in the inner space 4 of the container 2) drops below the driving pressure P₃ in the pressure control compartment 50, the movable wall part 49 will be moved in the operating direction F whereby the stem 34 is pressed downwards, i.e. in the direction of the first compartment. In this embodiment, the stem 34 is provided at its outside with a constriction 80 which, in the operative, closed position, is located above the shut-off 39 so that the opening 32 is closed. When the stem 34 is depressed, the widening 80 comes at least partly at the location of the seal, so that gas under high pressure P₂ can escape therealong to the connecting space 51 and, via the openings 48, to the inner space 3 of the container 2. As virtually the same pressure prevails at both ends of the stem, this pressure has virtually no influence on the force required for opening the flow path for the gas. If the stem 34 is biased by, for instance, a spring (not shown), in the closed position a suitable choice of surfaces of the ends of the stem 34 allows for compensation therefor, so that, also, the spring force has no influence on the force required for opening said flow path. During use, the forces engaging in opposite directions on the opposite ends of the stem, approximately compensate each other, irrespective of the pressures prevailing in the container or the first compartment.

FIGS. 10A-C show a further alternative embodiment of a pressure control 8 according to the invention, which has a build-up that is substantially comparable to that of FIG. 3. Here, the second housing 27 is provided, adjacent the first end 41 proximal to the first compartment, with openings 81 through which reaches a part of the first housing 26, such that the first housing is directly attached and secured to the body 15, at least in axial direction F. The first housing is provided, approximately at the location of the movable wall part 49 designed as membrane, with a shoulder 82 above which a number of cavities 31A are provided. The second housing 27 is provided directly above the openings 81 with snap fingers 66 which can engage in the cavities 31A. In the inoperative position (FIG. 10A) the snap fingers 66 are somewhat above the openings. Around the part of the first housing 26 above the shoulder 82, a gasket 67 is provided that forms a gliding shut-off against the inside of the second housing 27, which is closed off at the upper side by an end wall 83. As a result, between the first and second housing 26, 27, a closed pressure control compartment 50, variable in volume is obtained, in which, in the inoperative position (FIG. 10A), a relatively low pressure P₀ prevails, for instance atmospheric pressure. On the first stem 34, a pressing element 84, for instance a dish, is attached such that an axial sliding of the pressing element 84 results in an axial displacement of the stem 34 and hence in an opening or closing of the valve 33. The pressing element 84 is, by at least one portion of a longitudinal edge 85, below a first end 41 of the second housing 27. A bush 63 which is attached on the wall part 49 can, once more, slide over the stem 34 and the gaskets 61A, 61B, and is provided with an opening 65 for sealing and releasing the flow path for gas, from the first compartment 16, via the channel 62 and the outlet opening 60, through the opening 65 to the connecting chamber 51 an the inner space 3 of the container 2. Between the bush 63 and the wall part 49 a passage 86 is provided, which reaches into the space 79 within the bush 63 such that, each time, pressure equalization between that space 79 and the connecting space 51 can occur.

When, with this embodiment, the second housing 27 is displaced in axial operating direction F such that the snap finger 66 engage in the cavities 31A, the device is brought from the inoperative position (FIG. 10A) to the operative position (FIGS. 10B and C). The pressure in the pressure control compartment 50 is then increased to a desired control pressure P_{control}, at least in the operative, closed position (FIG. 10B), while the pressing element 84 is axially moved and, thus, the valve 33 is opened and held opened. In this operative, closed position, the bush 63 is positioned relative to the stem 34 such that the flow path for the gas under high pressure P₂ is thereby interrupted. When the pressure P₁ in the inner space 3 and, thus, in the connecting space 51 decreases, the wall part 49 is moved by the bush 63 in the operating direction F, towards the body 15 and the flow path is released, so that the pressure P1 in the inner space 3 can be returned to the desired level.

In the embodiments shown in FIGS. 3-10, each time, an inoperative position is shown, in addition to the two operative positions. However, it is also possible to design a pressure control 8, in particular a driving or pressure control device thereto without such an inoperative position. This is the case when, for instance, directly after or even during assembling, the pressure control is in an environment where the desired gas pressure prevails or can be set without much gas flowing away. This is the case for instance when the pressure control is assembled, at least set, and introduced into the container in line with a beverage filling device. In such an embodiment, the first and second housing can be directly intercoupled, in a fixed position, or even be integrated. Here, placing the driving control or pressure control device 90 on the body 15 will then result in the valve being opened and/or the control being put into operation. However, the inoperative position can have the advantage that with for instance atmospheric pressure, the pressure control can be stored for a longer period of time and, hence, can be manufactured and provided in the container off line of the filling device.

With the embodiments shown, when the pressure control is mounted such that at least a part thereof is accessible from the outside of the container 2, such as in the position shown in FIG. 2, the pressure control can be mechanically activated (be taken from an inoperative position) for instance manually by a user. If the pressure control is completely or partly included in the inner space 3 of the container, this can also be done by temporarily increasing the pressure in the container to a relatively high level, at least above the control pressure, so that, as a result of this pressure, the control is directly forced into the operative position. Such an excess pressure can be obtained by, for instance, introducing an amount of additional CO₂ into a headspace of a container filled with beverage. This will bring the desired pressure increase and after that for instance be absorbed by the beverage and/or be discharged with a first opening of the tapping means 7. As the headspace will be relatively small with respect to the amount of beverage, only little gas is required.

FIG. 11 shows an alternative embodiment of a device 1 according to the invention, wherein on the upper side of the container 2 a top ring 90 is attached, which top ring 90 reaches somewhat above the upper surface 5. In this embodiment, a tapping device 91 is used as described in, for instance, WO02/42197, wherein an operating knob 14 in the shape of a lever is provided with which the dispensing tube 13 can be lowered for opening the valve 12. For a further description, reference is made to WO02/42197, which publication is understood to be incorporated herein by reference. In the upper surface 5, a pressure control 8 is attached. In this embodiment, the second housing 27 is secured in an opening in the upper surface 5, through the use of, for instance, a folded seam connection, gluing, clamping or another suitable technique. As a result, the opening is gas-tightly sealed off while the openings 31 are located within the inner space 4. The first housing 16 is brought into the inoperative position and the body with the first compartment 16, in the embodiment shown for instance a known gas cartridge, can be separately supplied with the container or may already have been mounted on the first housing. In this embodiment, in the inoperative position, the first housing is placed on the side of the openings 31 proximal to the first end 41, as schematically shown in FIG. 11A at the left hand side. The snap fingers 66 are directed in an opposite direction relative to the earlier embodiments. In order to bring the pressure control 8 into the operative position, the body 15 with the first compartment is placed into the bush 63, for instance through a screw thread connection, clamping connection, bayonet catch or in a different manner, when this has not been mounted in advance in, for instance, the brewery or bottling plant. Then, the body 15 together with the first housing 26 are pressed in the direction of the at least partly closed second end 43 of the second housing such that the snap fingers 66 engage in the openings 31 and the upper end 45 of the first housing comes to lie against the inside of the second housing. Here, it is preferred that the second end 45 of the first housing is somewhat spherical and flexible in the inoperative position (FIG. 11A, left hand side). This means that upon movement towards the operative position, the curvature is partly or completely pressed away (FIG. 11A, right hand side), so that the volume of the pressure control compartment in the first housing is reduced and the control pressure P_{control} is set.

With a device according to the invention, the valve 33 of the pressure control can, in principle, be permanently opened. Here, the spring of this valve 33 has no effect on the force that is required for dispensing gas from the compartment 16, so that a still better control behaviour is obtained. As alternative, a valve 33 can be replaced by a different shut-off which can or cannot be permanently opened, such as for instance a pierceable seal, such as a membrane or a stop, a shut-off that can be pushed away such as, for instance, a stop, a valve or other alternative directly clear to the skilled person.

The invention is not limited in any manner to the embodiments represented in the description and the drawings. These are shown merely by way of illustration, many variations thereon are possible within the framework of the invention as outlined by the claims, among which, in particular, also combinations of parts of the embodiments shown. A pressure control according to the invention can be completely or partly included in an inner space of a container but can also be connected to a tapping rod of a known keg or to a filling opening of a “gravity”-can, comparable to the one according to FIG. 2 and as known from practice. These and comparable variations are understood to fall within the invention.

1. Container for dispensing beverage under pressure, which is provided with an inner space for receiving the beverage to be dispensed, wherein a pressure control is provided with a first compartment and a pressure control compartment closed towards the surroundings, wherein the first compartment is provided with a dispensing opening with a shut-off and driving means are provided on the pressure control compartment for opening the shut-off, wherein a channel is provided which, in opened position, is in open communication with the first compartment, wherein the pressure control compartment has a wall part movable in an operating direction relative to the first compartment, which bears an operating element which is slideable in, against or over said channel, and can release and seal-off a gas feed-through path between the first compartment and the surroundings, in particular by releasing or covering the outlet opening of the channel.

2. A container according to claim 1, wherein the pressure control compartment is provided with means for securing the shut-off in an opened position, wherein the outlet opening terminates directly or indirectly into the inner space of the container.

3. A container according to claim 1, wherein the pressure control device comprises an intermediate element which comprises at least a part of said channel and is movable between a first position and a second position, wherein, in the first position, it is located farther from the first compartment than in the second position.

4. A container according to claim 3, wherein the intermediate element comprises a bush which can link up with a stem of the shut-off such that a first part of the channel, which is located in the stem, links up with a second part of the channel, which is located in the intermediate element.

5. A container according to claim 3, wherein the intermediate element comprises a stem through which the channel reaches and which can be inserted into a part of the shut-off.

6. A container according to claim 1, wherein the outlet opening of the channel defines an outflow direction which includes an angle with the operating direction, preferably an angle between 30 and 150 degrees, more in particular between 60 and 120 degrees and preferably approximately 90 degrees.

7. A container according to claim 1, wherein the pressure control compartment is included in a first housing which is at least partly included in a slideable manner in the operating direction, in a second housing, which second housing is attached to the first compartment, while securing means are provided for securing the first housing relative to the second housing.

8. A container according to claim 1, wherein the pressure control compartment is included in a first housing and comprises a flexible or slideable wall part which forms at least partly said movable wall.

9. A container according to claim 3, wherein the pressure control compartment is included in a first housing which is at least partly included in a slideable manner in the operating direction, in a second housing, which second housing is attached to the first compartment, while securing means are provided for securing the first housing relative to the second housing, and wherein the intermediate element abuts against or forms part of the first housing.

10. A container according to claim 1, wherein in the pressure control compartment, at least one spring element is included for biasing the movable wall part in the direction of the shut-off.

11. A container according to claim 1, wherein, in the inner space, a first pressure prevails and in the first compartment a second pressure, while the second pressure is considerably higher than the first pressure.

12. A container according to claim 11, wherein in the pressure control compartment, with the container in rest, a control pressure prevails which is approximately equal to the first pressure.

13. A container according to claim 1, wherein, prior to a first dispensing of beverage from the inner space, the pressure control device is set such that pressure change in the pressure control compartment has no influence on the shut-off of the first compartment.

14. A container according to claim 1, wherein, prior to a first dispensing of beverage from the inner space, the pressure in the first compartment is higher than 10 bar, more particularly higher than 50 bar.

15. A container according to claim 1, wherein the volume of the first compartment is smaller than 1/25^{th} of the inner space, more particularly smaller than 1/50^{th}, and preferably smaller than 1/100^{th}.

16. A container according to claim 1, wherein the beverage is a carbonated beverage, in particular beer, and the pressure control device is set for controlling the pressure in the inner space to an equilibrium pressure.

17. A container according to claim 1, wherein the shut-off comprises a stem which comprises the channel, wherein the dispensing opening of the channel terminates into a pressure equalizing space of the operating element and can be sealed off thereby such that with the outlet opening opened, pressure equalization occurs between the pressure equalizing space and the first compartment and when said outlet opening is closed, the shut-off is movable by the respective movable wall part between an opened and a closed position.

18. A container according to claim 17, wherein prior to the first dispensing of beverage from the inner space, the channel, in particular the outlet opening, is sealed-off by a membrane, while the operating means are provided with piercing means for piercing said membrane.

19. A container for dispensing beverage under pressure, in particular according to claim 1, which container is provided with an inner space for receiving the beverage to be dispensed, wherein a pressure control is provided with a first compartment and a pressure control compartment sealed-off to the surroundings, wherein the first compartment is provided with a dispensing opening with a shut-off and driving means are provided on the pressure control compartment for opening the shut-off by displacing at least a part thereof in an operating direction, wherein the shut-off and the driving means are designed for setting approximately the same pressure on two sides of the shut-off, located opposite of each other viewed in operating direction.

20. A pressure control device for a container according to claim 1.

21. A pressure control device according to claim 17, wherein the at least one movable wall part is at least partly designed as a membrane, in particular a metal membrane.

22. A method for controlling the pressure in a container for dispensing beverage, wherein a pressure control is used with a shut-off of a high pressure gas compartment, which shut-off is moved in an operating direction between a closed position and an opened position, while, during use, at least with the shut-off in closed position or in opened position, on two sides of the shut-off located opposite each other in the operating direction, a pressure is set, in particular approximately said high pressure such that the force engaging the first one of said sides, in the operating direction, for closing the shut-off, is approximately equal to the force engaging the other one of said sides of the shut-off, in the operating direction, for opening the shut-off, while further, the shut-off is opened by a driving means driven by a pressure prevailing in the container.
